(19) United States
(12) Patent Application Publication
(10) Pub. No.: US 2005/0270280 A1
(43) Pub. Date: Dec. 8, 2005

(54) Video message device

(76) Inventors: Jack Riback, Scottsdale, AZ (US); Bob Dilworth, Santa Cruz, CA (US); Tom Headley, Scottsdale, AZ (US); Jim Packard, Scottsdale, AZ (US)

Correspondence Address: BROMBERG & SUNSTEIN LLP, 125 SUMMER STREET, BOSTON, MA, 02110-1618, US

(21) Appl. No.: 11/115,096

(22) Filed: Apr. 26, 2005

Related U.S. Application Data
(60) Provisional application No. 60/565,321, filed on Apr. 26, 2004.

(51) Int. Cl. G09G 5/00

(52) U.S. Cl. 345/204

(57) ABSTRACT

A video display device. The video display device includes a display device, a display, and a memory device for storing video data. A controller controls the display and the memory device so as to display a video sequence as a function of the video data stored in the memory device. The video display device may be adapted to be a trophy, a plaque, lapel pin, sports equipment, sports memorabilia, a trading card, a board game piece, a book marker, a key fob, a business card, a desk accessory, a promotional give-away item, a direct mail item, a refrigerator magnet or a souvenir.

### CROSS REFERENCE TO RELATED APPLICATIONS

This application claims priority from U.S. provisional application No. 60/565321, entitled “Video Message Device and Applications Thereof,” filed Apr. 26, 2004, which is hereby incorporated herein by reference, in its entirety.

### TECHNICAL FIELD

The present invention relates to video presentation, and more particularly, to a video display device for displaying video sequences that may be used in a wide variety of applications.

### BACKGROUND ART

Many items can be enhanced by a video image or series of video images. Examples of such items include trophies, refrigerator magnets, souvenirs, and lockets. However, incorporation of video into such items has been hampered, for example, by size, cost, complexity and/or power constraints.

Additionally, the manufacturer of such items typically does not have the capability to assemble the relatively complex video display device, and must choose from what is available in industry. However, current self-contained displays are generally of two types that are unsuitable for this particular use: 1) displays integrated into special use devices such as calculators and hand held games; and 2) increasingly sophisticated devices that require a lot of operator interaction to use the display—such as camera displays, computers, cell phones, and PDA devices. There are currently no self-contained, fully integrated electronic video display devices that are capable of displaying a wide range of video images and that further require no external inputs and minimal user interaction.

Furthermore, of great concern for many applications is that the video data stored into a video display device could be copied and consequently illegally distributed. For these applications, it is thus very advantageous to prevent downloading of the video data from video display device.

### SUMMARY OF THE INVENTION

In accordance with a first embodiment of the invention there is provided a video display device that includes a display, a memory device, and a unidirectional programming port for programming video data into the memory device. The video data stored in the memory device is incapable of being read via the unidirectional programming port. A controller displays a video sequence on the display, the video sequence displayed as a function of the video data stored in the memory device.

In accordance with another embodiment of the invention, a method of providing two or more video display devices is presented. Each device has a display, a memory device for storing video data, a programming port for programming the memory device, and a controller for controlling the display and the memory device so as to display a video sequence, the video sequence displayed as a function of the video data stored in the memory device. The method includes programming the memory device of each video display device with the same video data. The programming port of each video display device is disabled so as to prevent reading and programming of the memory device via the programming port.

In related embodiments, disabling the programming port may include sealing the programming port or breaking off the programming port.

In accordance with still another embodiment of the invention, a video display device includes a display, a memory device preprogrammed with video data, and a controller. The controller displays a video sequence on the display, the video sequence displayed as a function of the video data stored in the memory device. The device is void of a programming port.

In related embodiments, an activation means may activate the display of the video sequence on the display, the video sequence displayed as a function of the video data. The controller may display the entire video sequence upon activation of the activation means without further operator interaction. The controller may display the entire video sequence upon activation of the activation means based only on the video data stored in the memory device.

In accordance with yet another embodiment of the invention, a method of providing a video display device includes programming a memory device with video data. The programmed memory device, a display, and a controller are then assembled to form the video display device. The controller controls the display and the memory device so as to display a video sequence, the video sequence displayed as a function of the video data stored in the memory device.

In accordance with another embodiment of the invention, a method of providing a video display device includes assembling a memory device, a display, and a controller. After assembling, the memory device is programmed with video data. The programmed memory device, the display and the controller is then housed in a case, wherein the controller controls the display and the memory device so as to display a video sequence, the video sequence displayed as a function of the video data stored in the memory device.

In accordance with another embodiment of the invention, and/or related to the above-described embodiments, a video display device that includes a display, a memory device, and controller may be adapted to be a trophy, a plaque, a lapel pin, sports equipment, sports memorabilia, a trading card, a board game piece, a bookmarker, a key fob, a business card, a desk accessory, a promotional give-away item, a direct mail item, a refrigerator magnet, a greeting card or a souvenir. Alternatively, the video display device may be attached to a trophy, a plaque, clothing, sports equipment, sports memorabilia, a board game piece, a lamp, a bookmarker, a desk accessory, a clock, a bag label, a promotional give-away item, a direct mail item, a souvenir, a pet accessory, a purse, a wallet, a greeting card, or a magnet.

In accordance with another embodiment of the invention, and/or related to the above-described embodiments, the video display device that includes a display, a memory device, and controller includes an activation means for activating the display of a video sequence on the display. The video sequence is displayed as a function of the video data stored in the memory device. In various embodiments, the activation means may include one of a light sensor, a sound sensor, temperature sensor, a switch, a button, and a timer. The video data may include a first video sequence and a second video sequence, wherein the controller displays the first video sequence when the activation means is not activated, and displays the second video sequence when the activation means is activated. The controller may automatically display the first video sequence after displaying the second video sequence. The first video sequence may pertain to a time, a temperature, a pressure or a humidity.

In various embodiments, the video sequence may include an advertisement, instructions, a self-help message, a religious message, a sentimental message, an animation, an animate object, an inanimate object, and/or a sports event. The instructions may be, for example, a medical product, a pharmaceutical product or other type of product. The device may include a solar cell or battery for supplying power to the device. The video sequence may be a dynamic video sequence. The video sequence may be less than 30 seconds. The display may have a surface area of 8.75 square inches. The display may be, without limitation, substantially rigid or flexible. The device may include an audio means for providing audio.

### BRIEF DESCRIPTION OF THE DRAWINGS

The foregoing features of the invention will be more readily understood by reference to the following detailed description, taken with reference to the accompanying drawings, in which:

FIG. 1 is an illustration of a video display device, in accordance with an embodiment of the invention;

FIG. 2 is a block diagram of schematic-of a video display device, in accordance with an embodiment of the invention;

FIG. 3 is an illustration of a video display device attached to a trophy, in accordance with an embodiment of the invention;

FIG. 4 is an illustration of a video display device attached to a helmet, in accordance with an embodiment of the invention;

FIG. 5 is an illustration of a video display device attached to a sneaker, in accordance with an embodiment of the invention;

FIG. 6 is an illustration of a video display device attached to a magnet. in accordance with an embodiment of the invention;

FIG. 7(a) is an illustration of a video display device attached to a package for containing a product, wherein the video display device is displaying instructions, in accordance with an embodiment of the invention.

FIG. 7(b) is the package of FIG. 9(a), displaying further instructions upon activation of a button.

FIG. 8(a) is an illustration of a stand-alone video display device adapted to display a clock based on a first video sequence, in accordance with an embodiment of the invention;

FIG. 8(b) is the video display device of FIG. 8(a) displaying a second video sequence upon activation of a button.

FIG. 9(a) is a side view of a video display device contained in an egg-shaped enclosure, in accordance with an embodiment of the invention; and

FIG. 9(b) is a front view of video display device contained in the egg-shaped enclosure shown in FIG. 9(a).

### DETAILED DESCRIPTION OF SPECIFIC EMBODIMENTS

Definitions. As used in this description and the accompanying claims, the following terms shall have the meanings indicated, unless the context otherwise requires:

“Video” shall mean related to the electronic handling of visual images.

In illustrative embodiments, a display device is presented that can be mass-produced and used in a wide variety of applications. Among other things, the video display device may include a programming port that allows video data to be conveniently programmed into memory either by the display manufacturer or by the retailer. The programming port may be unidirectional, or may be capable of being disabled, such that copying of the video data is prevented. Alternatively, the video display device may not include a programming port and instead may include preprogrammed memory.

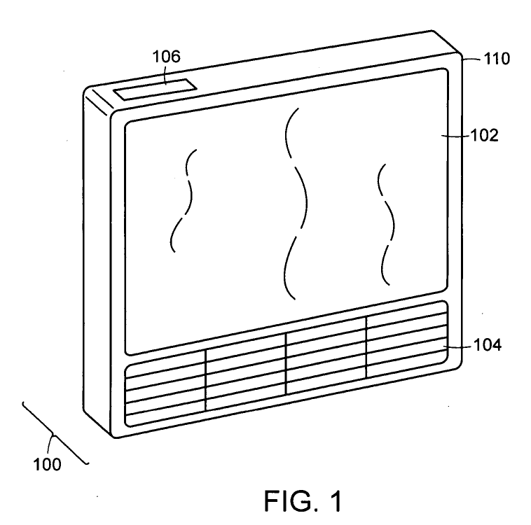

FIG. 1 is an illustration of a self-contained video display device 100, in accordance with an embodiment of the invention. The device 100 can be used as a standalone device, or may be attached to another item to provide video display capability, as discussed in more detail below.

The device 100 may have an enclosing case 110. The case 110 may be, for example, made of molded plastic or metal. The size of the case 110 is dependent on application. The shape of the case 110 is also variable depending on application, and may be, for example, rectangular, heart shaped, or football shaped.

The device 100 includes a display 102. The display 102 may be of various types known in the art, such as, but not limited to: a Liquid Crystal Display (LCD) that includes, for example, Twisted Nematic (TN) technology, Supertwisted Nematic (STN) technology, Polymer Dispersed Liquid Crystals (PDLC) and Bistable Cholesteric Liquid Crystals; a Plasma Display Panel (PDP); Alternate Lighting of Surfaces (ALiS); Plasma Addressed Liquid Crystal Display (PALCD); Field Emission Display (FED); Light-emitting Diodes (LEDs); OLED; Light Emitting Polymers (LEP); and electronic ink. The display may be, without limitation, substantially rigid or flexible.

The display 102 may be limited to black and white images, or may alternatively be capable of displaying colored images. The size and resolution of the display 102 is again dependent on application. For example, in applications constrained by size, the display 102 may have a surface area of 8.75 square inches or less. Larger size screens are also within the scope of the present invention, as are various aspect ratios, such as, without limitation, a 4 to 3 aspect ratio or a 16 to 9 aspect ratio.

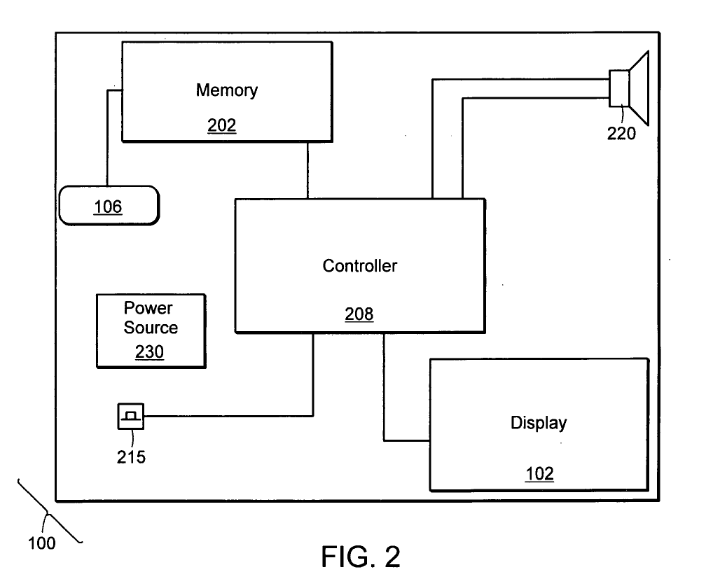

One or more power sources 230 (see FIG. 2) may provide power to the electronic circuitry/display included in the device 100. The power source may be a battery, which may be rechargeable. In various embodiments, the power source may include solar cells and/or photocells 104, working alone or in conjunction with the battery. In such embodiments, a sufficient amount of light shining on the photocells 104 may trigger for display one or more video sequences. When light is no longer shining on the photocell 104, the device 100 turns itself off and resets itself. Of course, it is to be understood that other sources of power can be used, such as, without limitation, AC-power from a wall socket, electromagnetic fields or radiation.

FIG. 2 is a block diagram of a schematic of the video display device 100, in accordance with an embodiment of the invention. The device 100 includes a memory device 202 for storing video data. In preferred embodiments, the memory device 202 is flash memory; however other memory devices known in the art may also be used, such as One-Time Programmable Read Only Memory (OTPROM) or a hard disk. The amount of memory required is dependent on the application. In various embodiments, the video data stored in the memory device 202 includes a video sequence(s) of a predetermined duration, such that the amount of memory required is known. The duration of the video sequence(s) may be kept short so as to decrease the amount of memory needed. For example, the video sequence may have, without limitation, a duration of 30 seconds or less. Longer or multiple video sequences are also within the scope of the present invention, increasing the amount of memory needed. For example, the duration of the video sequence may be, without limitation, 5 minutes or longer.

The video data stored in the memory device 202 may include dynamic video sequences that include motion, or substantially static video sequences. In various embodiments, the video data stored in the memory device 202 may include, without limitation, an animated video sequence that may be, for example, entirely computer generated.

A programming port 106 may be provided for programming the memory device 202 with video data. The programming port 106 is capable of communicating with a programming device that (not shown) for programming the memory device 202 with video data. The programming port 106 may include a wireless interface.

The programming port 106 may be bidirectional to allow programming or reading of the memory device 202. In other embodiments of the invention, the programming port 106 may be a unidirectional programming port. The unidirectional programming port allows data to be programmed into the memory device 202; however, video data stored in the memory device 202 is incapable of being read via the unidirectional programming port. For example, the device 100 may include separate programming and read data paths to the memory device 202, with the unidirectional programming port connected to only the programming data paths. In further embodiments, the programming port 106 (bidirectional or unidirectional) may be disabled after the memory device 202 has been programmed. Disabling the programming port 106 may be accomplished, for example, by sealing the programming port 106 or by breaking off the programming port 106. In still other embodiments, the video display device 100 may not include a programming port 106. Instead, the memory device 202 may be preprogrammed, for example, prior to assembly of the video display device 100. More particularly, the memory device 202 may be loaded with the video data either prior to assembling the memory device 202 into the video display device 100, or prior to assembling the video display device 100 into the case 110.

By disabling the programming port 106 and/or using a unidirectional programming port 106, or by preprogramming the memory device 202 prior to assembly of the device 100 so that no programming port is needed, a video display device 100 can be mass produced by a factory or retailer with preprogrammed video data that cannot be altered by the end user. That the preprogrammed video data cannot be viewed or altered by the end user can be important for certain applications. For example, the video data stored in the memory device 202 may include licensed video clips, such as a sports clip, which the manufacturer does not want the end user to copy and freely distribute. In another embodiment, the video data stored in the memory device 202 may include medical or pharmaceutical directions, which if altered, presents a health risk.

A controller 208 controls the display 102 and the memory device 202 to display a video sequence as a function of the video data stored in the memory device 202. The controller 208 may include, without limitation, control circuitry, a microchip, a microprocessor, a FPGA, software and/or microcode. In various embodiments, the controller 208 is specifically designed for the video display device 100, such that, for example, cost, size and/or power requirements are met. The video data stored in the memory device 202 is written to the display 102 by the controller 208 and displayed.

The video display device 202 may include an activation means 215 for activating the controller 208 to display a video sequence contained in the memory device 202. The activation means 215 may include, without limitation, a photocell for detecting light as described above, or other types of sensors, which may be used for example, to detect sound (such as a clap), motion and/or temperature. In various embodiments, the activation means 215 may include a button or other type of switch known in the art, which may require operator manipulation. The activation means may include a sensor for detecting the removal or replacement of an item, such as a pen in a pen holder, or a telephone on a cradle.

In various embodiments, the memory device 202 may be programmed with video data that includes two or more video sequences. Activation of the activation means 215 may cause each video sequences to be displayed, without limitation, sequentially or in random order. The video sequences may be displayed continuously until the activation means 215 is activated again, interrupting the display of the video sequences. In other embodiments, activation of the activation means 215 may cause each video sequence to be displayed only once.

The video data may include a first video sequence and a second video sequence. The first video sequence may be displayed when the activation means 215 is not activated, with a second video sequence(s) displayed only when the activation means is activated. The first video sequence may again be displayed after the second video sequence ends. The second video sequence(s) is thus “hidden” until the activation means 215 is activated. The first video sequence may pertain to a function that is normally displayed continuously, such as, without limitation, time, temperature, pressure and humidity.

In preferred embodiments of the invention, the video display device has no other operator interface other than activation means 215, which activates one or more video sequences 100 as described above. Upon activation, the one or more video sequences are displayed on the display 102 based on the video data stored contained in the memory device 202 without further operator interaction.

The video display device 100 may optionally include audio capability. For example, the video display device 100 may include one or more speakers 220.

The device 100 may be a standalone device that can be adapted to be used in a wide variety of applications. Alternatively, the self-contained video display device 100 may be attached to a wide variety of items to provide video display capability. The video display device 100 may be attached to the item by, without limitation, various adhesives or glues, Velcro, screws or other fasteners know in the art. For example, the video display device 100 may be self-contained in case 110, with the case attached to the item.

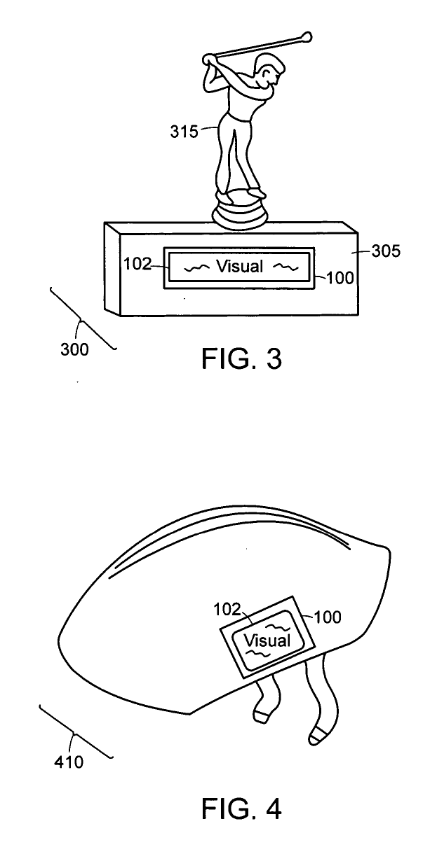

FIG. 3 is an illustration of the video display device 100 attached to a trophy 300 or other award, such as an awards plaque or medal. The trophy may include a base 305 and a figure object 315 protruding from the base 305. The figure object 315 may be related to the event associated with the award of the trophy. The video data within the memory device 202 may include, without limitation, video sequences of the event, or may be generally related to the type of event. For example, with regard to a trophy related to a hockey tournament, the video sequences may include specific highlights of the hockey game(s) in the tournament, a more generic video sequence pertaining to hockey (e.g., a video of a puck going through a goal), and/or a textual message that is scrolled across the display 102.

FIG. 4 is an illustration of the video display device 100 attached to a piece of sports equipment, and more particularly, a helmet 410. It is to be understood that there is a wide variety of sports equipment to which the case 1 10 may be attached, including, for example, a golf bag, a golf ball marker, bowling bag, skis, bicycles and backpacks.

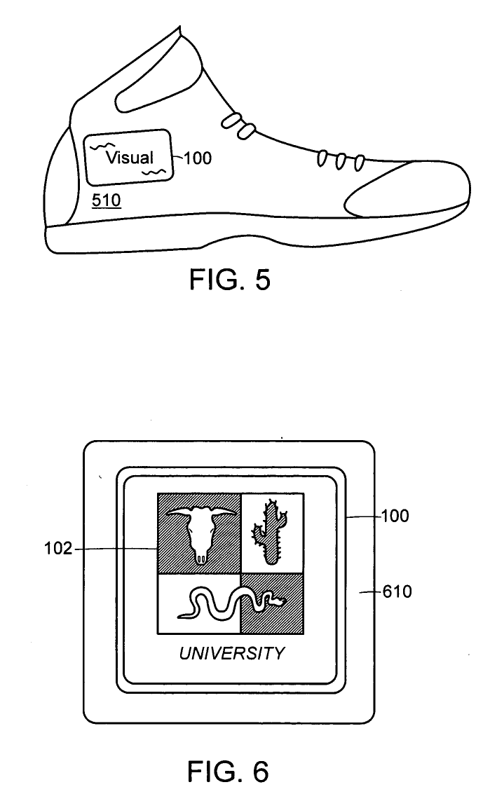

FIG. 5 is an illustration of the video display device 100 attached to a piece of clothing, and more particularly, without limitation, a sneaker 510. FIG. 6 is an illustration of the video display device 100 attached to a magnet 610. The magnet 610 may be placed, for example, onto a refrigerator or other metallic surface.

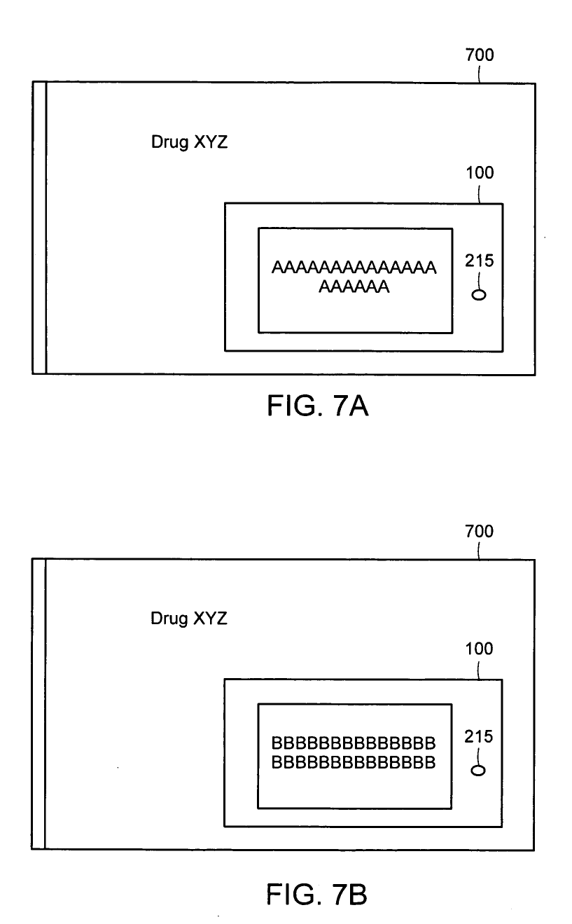

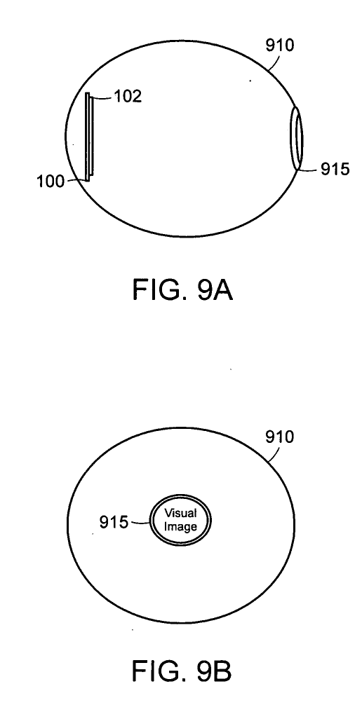

FIG. 7(a) is an illustration of a video display device 100 attached to a package 700 for containing a product, wherein the video display device 100 is displaying instructions, in accordance with an embodiment of the invention. FIG. 7(b) is the package of FIG. 9(a), displaying further instructions upon activation of a button 215. The product may be, without limitation, a drug, a medical device, or other products.

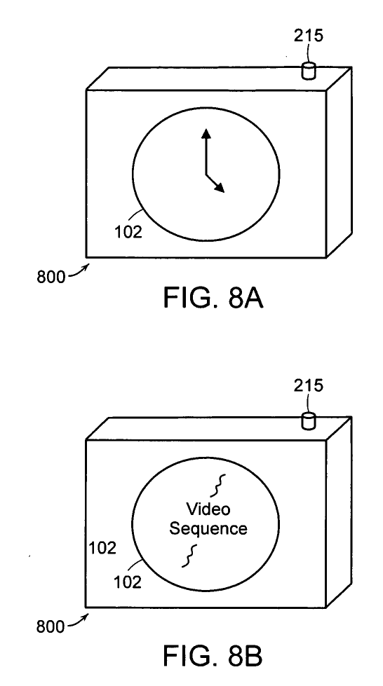

FIG. 8(a) is an illustration of a stand-alone video display device 800 adapted to be a clock and display the time based on a first video sequence, in accordance with an embodiment of the invention. FIG. 8(b) is the video display device of FIG. 8(a) displaying a second video sequence upon activation of a button 215. As described in above-embodiments, upon completion of the second video sequence, the video display device 800 may revert back to displaying the time.

The video display device is typically positioned on an outside surface of the item to which it may be attached. In other embodiments, the item may include an enclosure, with the video display device 100 contained within the enclosure. FIG. 9(a) is a side view and FIG. 9(b) is a front view of a video display device 100 contained within an item 910 that has an egg-shaped enclosure 912, in accordance with an embodiment of the invention. The item 910 includes a portal 915 for viewing the display 102. In such embodiments, the activation means 215 for activating the display of a video sequence on the display 102 may include various sensors that detect, without limitation, a sound or motion.

Still other items to which the self-contained video display device 100 may either be attached to or otherwise adapted to be include, without limitation: a piece of jewelry to be worn by a person, such as a locket, badge, bracelet charm, necklace pendant or brooch; a temperature, pressure and/or humidity gauge; a lapel pin; a holiday ornament; a holiday decoration; sports memorabilia; trading cards such as sports or pop culture trading cards; a key fob; a board game piece (e.g., a chess knight when touched displays an animation of a knight charging); a lamp, switch plate and/or night light; a book marker; a picture frame; a money clip; a bobble-head doll; clocks and/or timers, pen-sets; a desk accessory such as, without limitation, a paper weight, paperclip holder, and a pen holder; models of, without limitation, televisions, movie screens, cars, boats airplanes, and trains); religious plaques; sentimental items; souvenirs that may be, without limitation, a remembrance or a theme park item; promotional items; and various toys. Further items include, without limitation: a bag label, a direct-mail item, greeting cards, purses, handbags and wallets; a pet accessory; and business cards.

The video sequences included in the video data contained in the memory device 102 may vary greatly. Examples of video sequences, which are not meant to be limiting, include: instructions for using various products, such as a medical product or pharmaceutical product; self-help messages such as a stop eating or smoking message; advertisements, such as an advertisement for real estate; religious, educational or political messages; sporting sequences; music video sequences; logos; a sentimental message, an animation, an animate object, and an inanimate object.

In various embodiments, the disclosed controller may be implemented, at least in part, as a computer program product that includes a series of computer instructions fixed on a tangible medium, such as a computer readable media (e.g., a diskette, CD-ROM, ROM, or fixed disk). Those skilled in the art should appreciate that such computer instructions can be written in a number of programming languages for use with many processors.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

1. A video display device comprising:
a display;
a memory device;
a unidirectional programming port for programming video data into the memory device, the video data stored in the memory device incapable of being read via the unidirectional programming port; and
a controller for displaying a video sequence on the display, the video sequence displayed as a function of the video data stored in the memory device.

2. The device according to claim 1, further comprising providing an activation means for activating the display of the video sequence on the display, the video sequence displayed as a function of the video data.

3. The device according to claim 2, wherein the activation means includes one of a light sensor, a sound sensor, temperature sensor, a switch, a button, and a timer.

4. The device according to claim 2, wherein the video data includes a first video sequence and a second video sequence, and wherein the controller displays the first video sequence when the activation means is not activated, and displays the second video sequence when the activation means is activated.

5. The device according to claim 4, wherein the controller automatically displays the first video sequence after displaying the second video sequence.

6. The device according to claim 4, wherein the first video sequence pertains to one of a time, a temperature, a pressure and a humidity.

7. The device according to claim 1, wherein the device is adapted to be a standalone device.

8. The device according to claim 1, wherein the device is adapted to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, a greeting card and a souvenir.

9. The device according to claim 1, wherein the device is housed in a case.

10. The device according to claim 9, wherein the device is attached to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet, a greeting card, and a magnet.

11. The device according to claim 1, wherein the device is contained within an enclosure.

12. The device according to claim 1, wherein the video sequence includes at least one of an advertisement, instructions, a self-help message, a religious message, a sentimental message, an animation, an animate object, an inanimate object, and a sports event.

13. The device according to claim 12, wherein the instructions are for one of a medical product and a pharmaceutical product.

14. The device according to claim 1, wherein the device includes at least one of a solar cell and a battery for supplying power to the device.

15. The device according to claim 1, wherein the video sequence is a dynamic video sequence.

16. The device according to claim 1, wherein the display is substantially rigid.

17. The device according to claim 1, further comprising an audio means for providing audio.

18. The device according to claim 1, wherein the video sequence is less than 30 seconds.

19. The device according to claim 1, wherein the display has a surface area of 8.75 square inches.

20. The device according to claim 1, wherein the programming port includes a wireless interface.

21. A method of providing two or more video display devices, each device having a display, a memory device for storing video data, a programming port for programming the memory device, and a controller for controlling the display and the memory device so as to display a video sequence, the video sequence displayed as a function of the video data stored in the memory device, the method comprising:
programming the memory device of each video display device with the same video data; and
disabling the programming port of each video display device so as to prevent reading and programming of the memory device via the programming port.

22. The method according to claim 21, wherein disabling the programming port includes one of sealing the programming port and breaking off the programming port.

23. The method according to claim 21, further comprising providing on the video display devices an activation means for activating the display of a video sequence, the video sequence displayed as a function of the video data.

24. The method according to claim 23, wherein the activation means includes one of a light sensor, a sound sensor, temperature sensor, a switch, a button, and a timer.

25. The method according to claim 23, wherein programming the memory device includes programming the memory device with a first video sequence and a second video sequence, the method further comprising:
displaying the first video sequence when the activation means is not activated, and
displaying the second video sequence when the activation means is activated.

26. The method according to claim 25, wherein the first video sequence pertains to one of a time, a temperature, a pressure and a humidity.

27. The method according to claim 21, further comprising adapting each device as a standalone device.

28. The method according to claim 21, further comprising adapting the device to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, a greeting card and a souvenir.

29. The method according to claim 21, further comprising attaching the device to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet, a greeting card, and a magnet.

30. The method according to claim 21, wherein the device is contained in an enclosure.

31. The method according to claim 21, wherein programming the memory device includes programming the memory device with video data that includes one of an advertisement, instructions, a self-help message, a sentimental message, an animation, an animate object, an inanimate object, a religious message, and a sports event.

32. The method according to claim 31, wherein the instructions are for one of a medical product and a pharmaceutical product.

33. The method according to claim 21, wherein each device includes at least one of a solar cell and a battery for supplying power to the device.

34. The method according to claim 21, wherein a multiplicity of self-contained video display devices is provided.

35. The method according to claim 21, wherein programming the memory device includes programming video data that includes a dynamic video sequence.

36. The method according to claim 21, wherein the display is substantially rigid.

37. The method according to claim 21, wherein each device includes audio means for providing audio.

38. A video display device comprising:
a display;
a memory device for storing video data; and
a controller for controlling the display and the memory device so as to display a video sequence as a function of the video data stored in the memory device, the device adapted to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, and a souvenir.

39. The device according to claim 38, further comprising at least one of a solar cell and a battery for supplying power.

40. The device according to claim 38, wherein the memory device is flash memory.

41. The device according to claim 38, wherein the memory device is preprogrammed with video data.

42. The device according to claim 38, wherein the video data includes one of an advertisement, instructions, a self-help message, a religious message, a sentimental message, an animation, an animate object, an inanimate object, and a sports event.

43. The device according to claim 38, wherein the video data includes a dynamic video sequence.

44. The device according to claim 38, further comprising providing an activation means for activating the display of the video sequence on the display, the video sequence displayed as a function of the video data.

45. The device according to claim 44, wherein the video data includes a first video sequence and a second video sequence, and wherein the controller displays the first video sequence when the activation means is not activated, and displays the second video sequence when the activation means is activated.

46. The device according to claim 45, wherein the controller automatically displays the first video sequence after displaying the second video sequence.

47. The device according to claim 45, wherein the first video sequence pertains to one of a time, a temperature, a pressure and a humidity.

48. The device according to claim 38, wherein the display is substantially rigid.

49. The device according to claim 38, further comprising an audio means for providing audio.

50. A video display device comprising:
a display;
a memory device for storing video data; and
a controller for controlling the display and the memory device so as to display a video sequence as a function of the video data stored in the memory device, the video display device attached to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet and a magnet.

51. The device according to claim 50, further comprising at least one of a solar cell and a battery for supplying power.

52. The device according to claim 50, wherein the memory device is flash memory.

53. The device according to claim 50, wherein the memory device is preprogrammed with video data.

54. The device according to claim 50, wherein the video data includes one of an advertisement, instructions, a self-help message, a religious message, a sentimental message, an animation, an animate object, an inanimate object, and a sports event.

55. The device according to claim 50, wherein the video data includes a dynamic video sequence.

56. The device according to claim 50, further comprising providing an activation means for activating the display of the video sequence on the display, the video sequence displayed as a function of the video data.

57. The device according to claim 56, wherein the video data includes a first video sequence and a second video sequence, and wherein the controller displays the first video sequence when the activation means is not activated, and displays the second video sequence when the activation means is activated.

58. The device according to claim 57, wherein the controller automatically displays the first video sequence after displaying the second video sequence.

59. The device according to claim 57, wherein the first video sequence pertains to one of a time, a temperature, a pressure and a humidity.

60. The device according to claim 50, wherein the display is substantially rigid.

61. The device according to claim 50, further comprising an audio means for providing audio.

62. A video display device comprising:
a display;
a memory device preprogrammed with video data, the video data including a first video sequence and a second video sequence;
a controller for controlling the display and the memory device so as to display the first and second video sequence, and
an activation means for activating the display of the second video sequence, wherein the first video sequence is displayed when the activation means is not activated.

63. The device according to claim 62, wherein the activation means includes one of a light sensor, a sound sensor, temperature sensor, a switch, a button, and a timer.

64. The device according to claim 62, wherein the first video sequence is automatically displayed after completion of the second video sequence.

65. The device according to claim 62, wherein the first video sequence pertains to one of a time, a temperature, a pressure and a humidity.

66. A video display device comprising:
a display;
a memory device preprogrammed with video data; and
a controller for displaying a video sequence on the display as a function of the video data stored in the memory device, wherein the device is void of a programming port.

67. The device according to claim 66, further comprising providing an activation means for activating the display of the video sequence on the display, the video sequence displayed as a function of the video data.

68. The device according to claim 67, wherein the controller displays the entire video sequence upon activation of the activation means without further operator interaction.

69. The device according to claim 67, wherein the controller displays the entire video sequence upon activation of the activation means based only on the video data stored in the memory device.

70. The device according to claim 67, wherein the activation means includes one of a light sensor, a sound sensor, temperature sensor, a switch, a button, and a timer.

71. The device according to claim 67, wherein the video data includes a first video sequence and a second video sequence, and wherein the controller displays the first video sequence when the activation means is not activated, and displays the second video sequence when the activation means is activated.

72. The device according to claim 71, wherein the controller automatically displays the first video sequence after displaying the second video sequence.

73. The device according to claim 71, wherein the first video sequence pertains to one of a time, a temperature, a pressure and a humidity.

74. The device according to claim 66, wherein the device is adapted to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, a greeting card, and a souvenir.

75. The device according to claim 66, wherein the device is housed in a case.

76. The device according to claim 75, wherein the device is attached to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet, a greeting card, and a magnet.

77. The device according to claim 66, wherein the device is contained within an enclosure.

78. The device according to claim 66, wherein the video sequence includes at least one of an advertisement, instructions, a self-help message, a religious message, a sentimental message, an animation, an animate object, an inanimate object, and a sports event.

79. The device according to claim 78, wherein the instructions are for one of a medical product and a pharmaceutical product.

80. The device according to claim 66, wherein the device includes at least one of a solar cell and a battery for supplying power to the device.

81. The device according to claim 66, wherein the video sequence is a dynamic video sequence.

82. The device according to claim 66, wherein the display is substantially rigid.

83. The device according to claim 66, further comprising an audio means for providing audio.

84. A method of providing a video display device, the method comprising:
programming a memory device with video data; and
assembling the programmed memory device, a display, and a controller to form the video display device, the controller for controlling the display and the memory device so as to display a video sequence, the video sequence displayed as a function of the video data stored in the memory device.

85. The method according to claim 84, wherein assembling includes providing on the video display device an activation means for activating the display of a video sequence, the video sequence displayed as a function of the video data.

86. The method according to claim 85, wherein the activation means includes one of a light sensor, a sound sensor, temperature sensor, a switch, a button, and a timer.

87. The method according to claim 85, wherein programming the memory device includes programming the memory device with a first video sequence and a second video sequence, the method further comprising:
displaying the first video sequence when the activation means is not activated, and
displaying the second video sequence when the activation means is activated.

88. The method according to claim 87, wherein the first video sequence pertains to one of a time, a temperature, a pressure and a humidity.

89. The device according to claim 85, wherein the controller displays the entire video sequence upon activation of the activation means without further operator interaction.

90. The device according to claim 85, wherein the controller displays the entire video sequence upon activation of the activation means based only on the video data stored in the memory device.

91. The method according to claim 84, further comprising adapting the device as a standalone device.

92. The method according to claim 84, further comprising adapting the device to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, a greeting card and a souvenir.

93. The method according to claim 84, further comprising attaching the device to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet, a greeting card, and a magnet.

94. The method according to claim 84, further comprising placing the device in an enclosure.

95. The method according to claim 84, wherein programming the memory device includes programming the memory device with video data that includes one of an advertisement, instructions, a self-help message, a sentimental message, an animation, an animate object, an inanimate object, a religious message, and a sports event.

96. The method according to claim 95, wherein the instructions are for one of a medical product and a pharmaceutical product.

97. The method according to claim 84, wherein programming the memory device includes programming video data that includes a dynamic video sequence.

98. A method of providing a video display device, the method comprising:
assembling a memory device, a display, and a controller;
programming the memory device with video data; and
housing the programmed memory device, the display and the controller in a case, wherein the controller controls the display and the memory device so as to display a video sequence, the video sequence displayed as a function of the video data stored in the memory device.

99. The method according to claim 98, wherein assembling includes providing an activation means for activating the display of a video sequence, the video sequence displayed as a function of the video data.

100. The method according to claim 99, wherein the activation means includes one of a light sensor, a sound sensor, temperature sensor, a switch, a button, and a timer.

101. The method according to claim 99, wherein programming the memory device includes programming the memory device with a first video sequence and a second video sequence, the method further comprising:
displaying the first video sequence when the activation means is not activated, and
displaying the second video sequence when the activation means is activated.

102. The method according to claim 101, wherein the first video sequence pertains to one of a time, a temperature, a pressure and a humidity.

103. The device according to claim 99, wherein the controller displays the entire video sequence upon activation of the activation means without further operator interaction.

104. The device according to claim 99, wherein the controller displays the entire video sequence upon activation of the activation means based only on the video data stored in the memory device.

105. The method according to claim 98, further comprising adapting the device as a standalone device.

106. The method according to claim 98, further comprising adapting the device to be one of a trophy, a plaque, a lapel pin, sports equipment, sports memorabilia, a trading card, a board game piece, a book marker, a key fob, a business card, a desk accessory, a promotional give-away item, a direct mail item, a refrigerator magnet, a greeting card, and a souvenir.

107. The method according to claim 98, further comprising attaching the device to one of a trophy, a plaque, clothing, sports equipment, sports memorabilia, a board game piece, a lamp, a book marker, a desk accessory, a clock, a bag label, a promotional give-away item, a direct mail item, a souvenir, a pet accessory, a purse, a wallet, a greeting card, and a magnet.

108. The method according to claim 98, further comprising placing the device in an enclosure.

109. The method according to claim 98, wherein programming the memory device includes programming the memory device with video data that includes one of an advertisement, instructions, a self-help message, a sentimental message, an animation, an animate object, an inanimate object, a religious message, and a sports event.

110. The method according to claim 109, wherein the instructions are for one of a medical product and a pharmaceutical product.

111. The method according to claim 98, wherein programming the memory device includes programming video data that includes a dynamic video sequence.
